(19) United States
(12) Patent Application Publication
(10) Pub. No.: US 2008/0167198 A1
(43) Pub. Date: Jul. 10, 2008

(54) Filter based detection system

(76) Inventors: Christopher Gerard Cooney, Severn, MD (US); Matthew Jerome Lesho, Ellicott City, MD (US)

Correspondence Address: ANDREWS KURTH LLP;Intellectual Property Department, Suite 1100, 1350 I Street, N.W., Washington, DC, 20005, US

(21) Appl. No.: 11/649,221

(22) Filed: Jan. 4, 2007

(51) Int. Cl. C40B 30/00; B01J 19/00; C40B 60/12; G01N 1/28; G01N 21/76

(52) U.S. Cl. 506/7; 422/68.1; 422/82.05; 422/82.08; 506/39; 436/172; 436/178

(57) ABSTRACT

The present invention provides an apparatus and a method for detecting an analyte in a liquid sample with reduced complexity and response time without sacrificing multiplexing capabilities or limits of detection requirements. The apparatus comprises a cartridge, a sample loader, and a base unit. The cartridge comprises a reaction chamber having a filter in the sample flow path for capturing the analyte of interest in the sample, a waste reservoir connected to the reaction chamber via the filter, and a reagent chamber containing reagents for an amplification reaction. The sample is loaded into the cartridge from the sample loader. The analyte of interest is captured on the filter and subjected to an amplification reaction. The amplification product is detected by a detector in the base unit.

### TECHNICAL FIELD

The present invention generally relates to methods and apparatus for detecting an analyte in a liquid sample. More particularly, the present invention relates to a method and device that capture the analyte on a filter and identify the captured analyte.

### BACKGROUND OF THE INVENTION

Collection of liquid specimens for laboratory analysis is well known. Typically, a liquid specimen or a swab is collected and, depending on the desired assay, the appropriate component of the specimen is extracted. In cases where the desired component is cellular or subcellular, the specimens are generally centrifuged to pellet the cells. The cell pellets are then lysed to release the cellular or subcellular component. Alternatively, lysis may occur prior to centrifugation and the pelleted debris can be analyzed. Because centrifugation equipment is not readily portable, specimen collection, especially high-volume liquid specimen collections, have generally been limited to the clinical or laboratory setting.

The centrifugation step is normally done at the collection site. In order to perform the collection and analysis using this system, the collection of the specimen must be at a site where equipment is available for centrifugation and extraction. In addition, only a small percentage of the total specimen is required for tests. This means that since the entire specimen must be kept viable, the entire specimen must be stored until the extraction step is completed. In a typical example, only one percent of the specimen is required for an analysis. This means 99% of the storage specimen is ultimately discarded. By maintaining such a large specimen, the costs of transportation, storage and disposal of the specimen becomes critical. Moreover, in order to analyze the specimens properly, the specimens must be collected in fluid form in a sterile container, sealed and transported to the central centrifugation and extraction site. This is true for most specimens of bodily fluids and environmental specimens collected on site.

In summary, sample preparation and identification of the analyte of interest in the sample typically require many steps that are often manual. Analytical systems that automate these procedures typically require a large duration to perform the fluidic handling. Thus, reducing the number of fluidic steps, particularly for hand-held systems, has the potential to reduce the sample-to-answer response time as well as the complexity of the device.

### SUMMARY OF THE INVENTION

The present invention provides an apparatus and a method for detecting an analyte in a liquid sample with reduced complexity and response time without sacrificing multiplexing capabilities or limits of detection requirements.

One aspect of the present invention relates to a filter-based device for detecting an analyte is a liquid sample. The device comprises a cartridge comprising a reaction chamber having a filter in a sample flow path for capturing the analyte in the sample; a waste reservoir connected to the reaction chamber via the filter, the waste reservoir collects the flow-through sample from the filter; and a reagent chamber containing reagents for an amplification reaction in the reaction chamber, the reagent chamber is in fluid communication with the reaction chamber after all the sample enters the waste reservoir.

In one embodiment, the waste reservoir is connected to the filter through a check valve that prevents the flow-through sample from entering the reaction chamber.

In another embodiment, the cartridge further comprises a buffer reservoir containing a buffer that is used to reconstitute the reagents from a lyophilized reagent pellet in the reagent chamber.

In another embodiment, the reagent chamber is connected to the reaction chamber via a check valve that prevents the liquid sample from entering the reagent chamber.

In another embodiment, the filter-based device further comprises a sample loader for loading the liquid sample into the cartridge through a sample port.

In another embodiment, the filter-based device further comprises a base unit comprising an optical device for detecting a signal from the reaction chamber, a heating/cooling device, and a pressure device.

In another embodiment, the optical device is a fluorescence detector comprising light-emitting diode (LED) illuminators and a diode array.

In another embodiment, the reaction chamber further comprises a spot array having spots that fluoresce after the amplification reaction.

Another aspect of the present invention relates to a method for detecting an analyte in a liquid sample. The method comprises the steps of: loading a liquid sample into a cartridge containing a filter having a pore size sufficient to captured the analyte when the sample flows through the filter, the filter is located in a reaction chamber in the cartridge; introducing into the reaction chamber reagents from a reagent chamber in the cartridge to initiate an amplification reaction; and detecting a product of the amplification reaction.

In one embodiment, the method further comprises the step of applying a pressure at a pressure port of the cartridge to break a septum between a buffer reservoir and the reagent chamber to reconstitute reagents from a lyophilized reagent pellet.

In another embodiment, the amplification reaction is an exponential amplification reaction (EXPAR), a strand displacement amplification (SDA), or a polymerase chain reaction (PCR), and the product of the amplification reaction is detected by fluorescence.

These and other embodiments of the invention are further described below with references to the following figures.

### BRIEF DESCRIPTION OF THE FIGURES

FIGS. 1A and 1B are schematics showing an embodiment of the filter-based detection system of the present invention.

FIGS. 2A and 2B are schematics showing another embodiment of the filter-based detection system of the present invention.

FIG. 3 is a schematic showing a third embodiment of the filter-based detection system of the present invention.

FIG. 4 is a schematic showing a fourth embodiment of the filter-based detection system of the present invention.

### DETAILED DESCRIPTION OF THE INVENTION

In describing preferred embodiments of the present invention, specific terminology is employed for the sake of clarity. However, the invention is not intended to be limited to the specific terminology so selected. It is to be understood that each specific element includes all technical equivalents which operate in a similar manner to accomplish a similar purpose.

One aspect of the present invention provides an apparatus and method for analyzing a fluid sample. The invention provides a cartridge for separating an analyte from a fluid sample and for holding the analyte for a chemical reaction. The fluid sample may be a solution, a suspension, or a solid made soluble or suspended in a liquid. The fluid sample may be an environmental sample such as airborne particles or dust placed in a liquid, ground or waste water, or soil extracts. The fluid sample may also be a bodily fluid (e.g., blood, urine, saliva, sputum, seminal fluid, spinal fluid, mucus, or other bodily fluids). Further, the fluid sample may be mixed with one or more chemicals, reagents, diluents, or buffers. The fluid sample may also be pretreated, for example, sonicated, heated, subjected to freeze-thaw cycles, centrifuged, etc.

The fluid sample may be introduced into the cartridge by a variety of means, manual or automated. For manual addition, a measured volume of sample material may be placed into the cartridge through an input port. Alternatively, a greater amount of sample material than required for the analysis can be added to the cartridge and mechanisms within the cartridge can effect the precise measuring and aliquoting of the sample needed for the specified protocol.

For automated sample introduction, additional design features of the cartridge are employed and, in many cases, impart specimen accession functionality directly into the cartridge. With certain samples, such as those presenting a risk of hazard to the operator or the environment, such as biowarfare agent, the transfer of the sample to the cartridge may pose a risk. Thus, in one embodiment, a sample collector may be integrated into the cartridge so that the cartridge itself may also serve as the actual specimen collection device, thereby reducing handling and exposure.

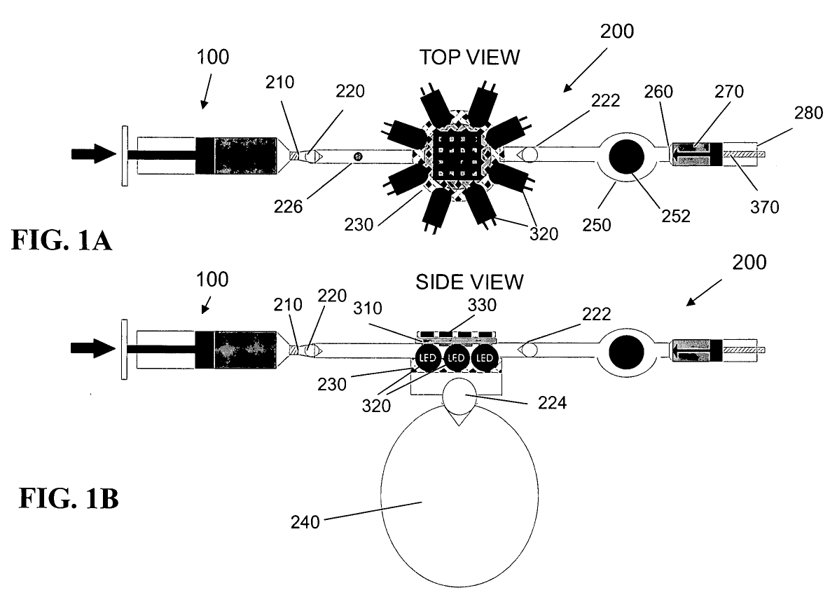

FIGS. 1A and 1B show an embodiment of the filter based detection system of the present invention. The system 10 comprises a sample holder 100, a cartridge 200, and a base unit 300 (not shown in FIG. 1). The sample holder 100 is a consumable container that contains the liquid sample to be tested. In one embodiment, the sample holder 100 is a disposable syringe.

The cartridge 200 comprises a sample port 210 that is receptive to the sample holder 100, check valves 220, 222 and 224, a filter 230, a reaction chamber 232 formed on top the filter 230, a waste reservoir 240, a reagent chamber 250 having a lyophilized reagent pellet 252, a buffer reservoir 270, and a pressure port 280 at one end of the buffer reservoir 270. The buffer reservoir 270 is separated from the reagent chamber 250 by a septum 260 to prevent moisture from prematurely hydrating the reagent pellet 252. The buffer in the buffer reservoir 270 can be water or any buffer suitable for reconstituting the reagent pellet 252.

When a sample is loaded into the cartridge 200 from the sample holder 100, check valve 220 and 222 prevent the sample from entering the reagent chamber 250 and from flowing back out of the cartridge 200. The sample flows through the filter 230 and enters the waste reservoir 240, which has an additional check valve 224 to prevent back flow (FIG. 1B) as the sample holder 100 is dispensed. In one embodiment, the waste reservoir 240 is a collapsable reservoir. As will be discussed in more detail below, the pore size of the filter 230 is selected based on the analyte of interest, such as bacteria spores, large viruses and genomic DNA and RNA. The filtration step is designed to concentrate the analyte in the sample and to remove contaminants from the sample.

In the next step, the trapped analyte is exposed to reagents for subsequent amplification reactions. In one embodiment, a wax seal is melted to open a vent 226 to the atmosphere (FIG. 1A). A pump or step motor then applies pressure to the pressure port 280 by, for example, advancing a plunger 370 into the pressure port 280 and breaking the septum 260. The buffer or water contained within the buffer reservoir 270 then fills the reagent chamber 250 and rehydrates the lyophilized pellet 252. In another embodiment, the check valve 222 is replaced with a wax valve, which is melted after the filtration step. In this embodiment, the buffer released from the buffer reservoir 270 is stirred by a back-and-forth motion of the plunger 370 so as to uniformly reconstitute the reagent pellet 252. The reconstituted reagent is then advanced to the reaction chamber 232. In yet another embodiment, the reagent is provided through the filter 230 in retrograde fashion.

In the above description wax and check valves are used as example embodiments to control the flow of liquid in the cartridge 200. However, this is not meant to be limiting and other valve systems are also possible solutions including mechanically, or electromechanically actuated, or “breakthrough” pressure systems.

The amplification reaction can be any reaction capable of amplifying a signal from the analyte trapped on the filter 230. The reactions may include both thermal cycling amplification methods and isothermal amplification methods. Suitable thermal cycling methods include, but are not limited to, the Polymerase Chain Reaction (PCR; U.S. Pat. Nos. 4,683,202, 4,683,195 and 4,965,188); Reverse Transcriptase PCR (RT-PCR); DNA Ligase Chain Reaction (LCR; International Patent Application No. WO 89/09835); and transcription-based amplification (Kwoh et al. 1989, Proc. Natl. Acad. Sci. USA 86, 1173-1177). Suitable isothermal amplification methods useful in the practice of the present invention include, but are not limited to, Exponential Amplification Reaction (EXPAR; Van Ness et al., 2003, Proc. Natl. Acad. Sci. USA, 100:4504-4509), Rolling Circle Amplification (RCA, Lizardi, et al., 1998, Nat. Genet. 19:225-232), Strand Displacement Amplification (SDA; Walker et al. 1992, Proc. Natl. Acad. Sci. USA 89, 392-396); Q-β replicase (Lizardi et al. 1988, Biotechnology 6, 1197-1202), Nucleic Acid-Based Sequence Amplification (NASBA; Sooknanan et al. 1995, Bio/Technology 13, 563-65), and Self-Sustained Sequence Replication (3SR; Guatelli et al. 1990, Proc. Natl. Acad. Sci. USA 87, 1874-1878).

The amplified signals, typically in the form of fluorescence, are detected by an optical detector 310 within the base unit 300. The detector 310 can be any devices capable of detecting fluorescence signals. One skilled in the art would understand that many optical designs could be used for the detection of fluorescence signals. The embodiment illustrated in FIGS. 1A and 1B use LED illumination 320 from the side and detection with a photodiode array 330 on the bottom of a reaction chamber 232. A selective optical filter may be used to minimize wavelengths that correspond to the excitation source and allows transmission of the fluorescent light.

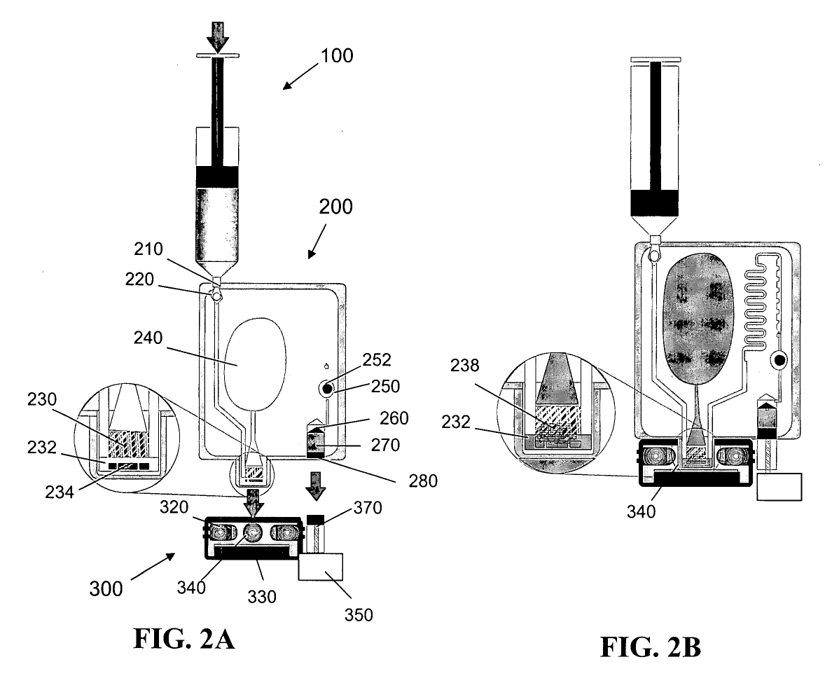

As shown in the exploded views in FIGS. 2A and 2B, the reaction chamber 232 is made of optically transmissive material for in situ optical interrogation of the reaction mixture in the reaction chamber 232 by the detector 310.

Optimum optical sensitivity may be attained by maximizing the optical path length of the light beams exciting the labeled analyte in the reaction mixture and the emitted light that is detected, as represented by the equation:

Iₒᵤₜ/Iᵢₙ=C*L*A

where Iₒᵤₜ is the illumination output of the emitted light in volts, photons or the like, C is the concentration of analyte to be detected, Iᵢₙ is the input illumination, L is the path length, and A is the intrinsic absorptivity of the dye used to label the analyte.

Preferably, the reaction chamber 232 is in a shape that provides a relatively large average optical path length through the chamber, while still keeping the chamber sufficiently thin to allow for extremely rapid heating and cooling of the reaction mixture contained therein.

The reaction chamber 232 may be heated and cooled by a heating/cooling unit in the base unit 300. Various thermal elements may be employed to heat and/or cool the reaction chamber 232 and thus control the temperature of the reaction mixture in the chamber 232. In general, suitable heating elements include conductive heaters, convection heaters, or radiation heaters. Examples of conductive heaters include resistive or inductive heating elements coupled to walls of the reaction chamber 232, e.g., resistors or thermoelectric devices. Suitable convection heaters include forced air heaters or fluid heat-exchangers for flowing fluids past the plates. Suitable radiation heaters include infrared or microwave heaters. Similarly, various cooling elements may be used to cool the plates. For example, various convection cooling elements may be employed such as a fan, peltier device, refrigeration device, or jet nozzle for flowing cooling fluids past the surfaces of the plates. Alternatively, various conductive cooling elements may be used, such as a heat sink, e.g. a cooled metal block, in direct contact with the plates.

As noted above, the cartridge 200 and the base unit 300 may be used to conduct chemical reactions other than nucleic acid amplification. Further, although fluorescence excitation and emission detection is preferred, optical detection methods such as those used in direct absorption and/or transmission with on-axis geometries may also be used to detect analyte in the cartridge. Another possible detection method is time decay fluorescence. Additionally, the cartridge is not limited to detection based upon fluorescent labels. For example, detection may be based upon phosphorescent labels, chemiluminescent labels, or electrochemiluminescent labels.

In one embodiment, the reaction chamber 232 is heated to a constant temperature (e.g., 60° C.) to initiate the amplification reaction. The reaction proceeds according to the protocol of the EXPAR assay (Van Ness et al., 2003, Proc. Natl. Acad. Sci. USA, 100:4504-4509) such that oligonucleotides (e.g. 24 mers) are released from a target genomic DNA. These oligonucleotides diffuse across the reaction chamber 232 (and bind to “templates” bound to the inner bottom surface of the reaction chamber 232. These templates, organized as spots 234 for specific targets, are designed to be complementary to the oligonucleotides released from the target genomic DNA 238 (FIG. 2B). Alternatively, the spots 234 could be attached directly to the filter 230. Upon binding of the oligonucleotides to the templates, an exponential amplification reaction proceeds, according to the EXPAR assay protocol, and causes the spots 234 to fluoresce. Multiple spots 234 provide a multiplexing capacity and the ability to run internal controls. The spots 234 should be placed in close proximity to the filter 230 to enable short diffusional path length of targets to the spots 234 for efficient in situ amplification. In one embodiment, the distance between the spots 234 and the filter 230 is from about 0.1 mm to about 2 mm, preferably between about 0.1 mm to about 1 mm, and more preferably between about 0.2 mm to about 0.6 mm.

Referring to FIGS. 2A and 2B, the cartridge 200 is preferably used in combination with the base unit 300 designed to accept one or more of the cartridges 200. For clarity of illustration, the base unit 300 shown in FIGS. 2A and 2B accepts just one cartridge 200. It is to be understood, however, that the base unit 300 may be designed to process multiple cartridges simultaneously. The base unit 300 includes a cartridge nest 340 into which the cartridge 200 is placed for processing. The base unit 300 also includes a pump 350 for advancing the plunger 370 into the pressure port 280 of the cartridge 200. The pump 350 may be any device capable of advancing the plunger 370 is a regulated manner, including but are not limited to, step motors, syringe pumps, compressed air sources, pneumatic pumps, or any regulated pressure sources that may advance the plunger 370 into the filter cartridge 200 through the pressure port 280.

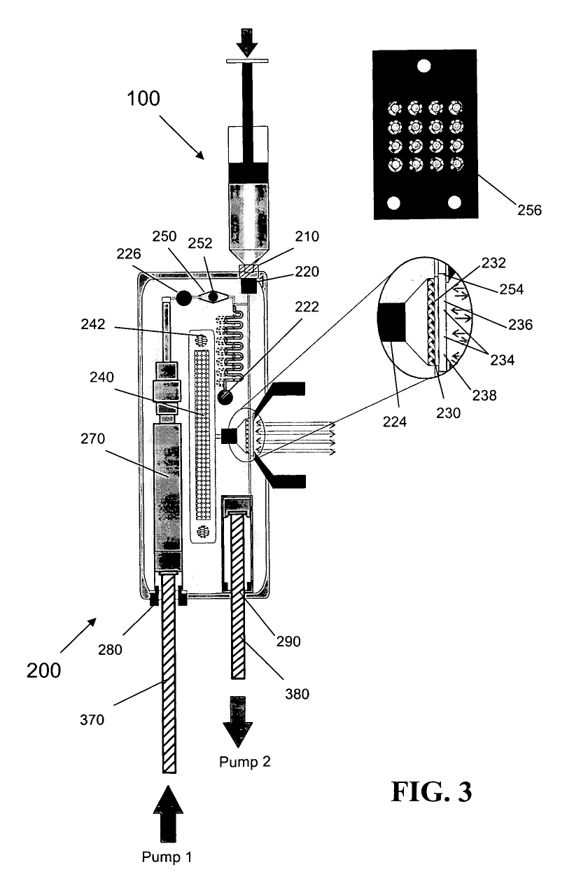

FIG. 3 shows another embodiment of the cartridge 200. In this embodiment, the sample is introduced into the cartridge 200 through the sample port 210, passes the filter 230 and enters the waste reservoir 240 which is filled with an absorbent material and vented to the atmosphere through vents 242. In a preferred embodiment, the vents 242 are covered with a hydrophobic material, such as Teflon™ to prevent samples from leaking through the vents 242. Check valve 222 prevents the sample from contacting the lyophilized pellet 252.

After loading the sample, the sample loader 100 is discarded. Check valve 224 prevents the sample in the waste reservoir 240 from flowing back out of the filter 230 when the sample loader 100 is removed from the cartridge 200. The cartridge 200 is then inserted into the base unit 300. The insertion of cartridge punctures septum 260. A first pump advances the plunger 370 into the cartridge 200 through the pressure port 280 to force the buffer in the buffer reservoir 270 into the reagent chamber 250 to dissolve the lyophilized reagent pellet 252. A second pump then pulls back a second plunger 380 through a second pressure port 290 to suck the reconstituted reagent into the reaction chamber 232, which is formed between the filter 230 and a glass slide 238 mounted on a silicon gasket 254 (exploded view in FIG. 3). In one embodiment, the distance between the filter 230 and the glass slide 238 is in the range for about 0.2 mm to about 0.6 mm. The reaction chamber 232 can be heated with, for example, a metal cylindrical heater assembly that contacts the thermally-conductive silicone gasket 254 to initiate the amplification reaction. The movement of the two pumps are coordinated to control the amount of reagents passing through the surface of the filter 230. In one embodiment, check valve 226 also contains a vent to atmosphere so that air slugs may be introduced to bracket the reagent and ensure reproducible results.

The spots 234, arranged as a spot array 236, are attached to the glass slide 238 and can be optically interrogated by illumination from the side. In a preferred embodiment, a mask 256, which is mounted on the back side of the glass slide 238 with through holes for spot illumination and alignment, is used to prevent interference among spots 234 of the array 236.

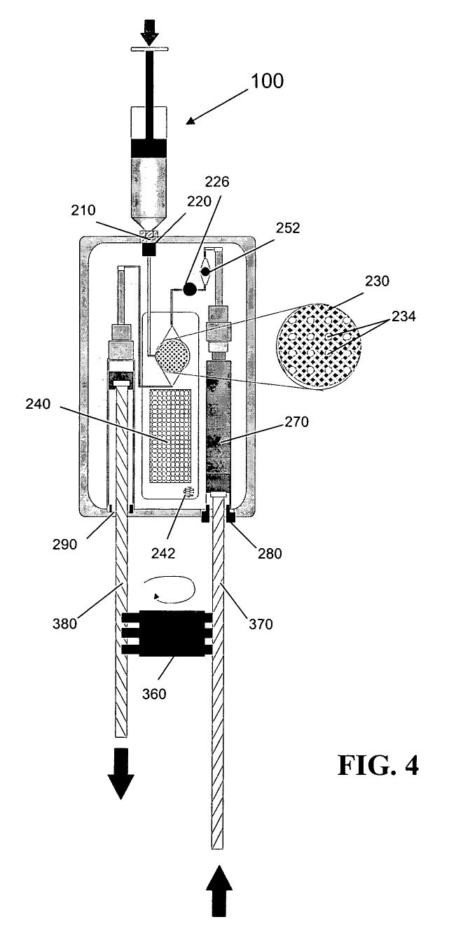

FIG. 4 shows another embodiment of the cartridge 200. In this embodiment, plungers 272 and 274 are controlled by a single actuator 360 that alternatively pulls and pushes the plungers 272 and 274, so that the two plungers are always moving towards opposite directions. The spot array 236 is optically interrogated from above.

The target analyte of the present invention is typically biomolecules (e.g., nucleic acid, proteins, carbohydrates, and lipids) from a cell or a virus particle. In a preferred embodiment, the analyte is nucleic acid which the cartridge separates from the fluid sample and holds for amplification (e.g., using PCR, EXPAR or SDA) and optical detection. As used herein, the term “nucleic acid” refers to any synthetic or naturally occurring nucleic acid, such as DNA or RNA, in any possible configuration, i.e., in the form of double-stranded nucleic acid, single-stranded nucleic acid, or any combination thereof.

Examples of the cells of interest include, but are not limited to, eukaryotic and prokaryotic cells, parasites, and bacteria. Examples of eukaryotic cells include all types of animal cells, such as mammal cells, reptile cells, amphibian cells, and avian cells, blood cells, hepatic cells, kidney cells, skin cells, brain cells, bone cells, nerve cells, immune cells, lymphatic cells, brain cells, plant cells, and fungal cells. In another aspect, the cells can be a component of a cell including, but not limited to, the nucleus, the nuclear membrane, leucoplasts, the microtrabecular lattice, endoplasmic reticulum, ribosomes, chromosomes, cell membrane, mitochondrion, nucleoli, lysosomes, the Golgi bodies, peroxisomes, or chloroplasts.

Examples of bacteria include, but are not limited to, Abiotrophia, Achromobacter, Acidaminococcus, Acidovorax, Acinetobacter, Actinobacillus, Actinobaculum, Actinomadura, Actinomyces, Aerococcus, Aeromonas, Afipia, Agrobacterium, Alcaligenes, Alloiococcus, Alteromonas, Amycolata, Amycolatopsis, Anaerobospirillum, Anaerorhabdus, Arachnia, Arcanobacterium, Arcobacter, Arthrobacter, Atopobium, Aureobacterium, Bacteroides, Balneatrix, Bartonella, Bergeyella, Bifidobacterium, Bilophila Branhamella, Borrelia, Bordetella, Brachyspira, Brevibacillus, Brevibacterium, Brevundimonas, Brucella, Burkholderia, Buttiauxella, Butyrivibrio, Calymmatobacterium, Campylobacter, Capnocytophaga, Cardiobacterium, Catonella, Cedecea, Cellulomonas, Centipeda, Chlamydia, Chlamydophila, Chromobacterium, Chyseobacterium, Chryseomonas, Citrobacter, Clostridium, Collinsella, Comamonas, Corynebacterium, Coxiella, Cryptobacterium, Delftia, Dermabacter, Dermatophilus, Desulfomonas, Desulfovibrio, Dialister, Dichelobacter, Dolosicoccus, Dolosigranulum, Edwardsiella, Eggerthella, Ehrlichia, Eikenella, Empedobacter, Enterobacter, Enterococcus, Erwinia, Erysipelothrix, Escherichia, Eubacterium, Ewingella, Exiguobacterium, Facklamia, Filifactor, Flavimonas, Flavobacterium, Francisella, Fusobacterium, Gardnerella, Gemella, Globicatella, Gordona, Haemophilus, Hafnia, Helicobacter, Helococcus, Holdemania Ignavigranum, Johnsonella, Kingella, Klebsiella, Kocuria, Koserella, Kurthia, Kytococcus, Lactobacillus, Lactococcus, Lautropia, Leclercia, Legionella, Leminorella, Leptospira, Leptotrichia, Leuconostoc, Listeria, Listonella, Megasphaera, Methylobacterium, Microbacterium, Micrococcus, Mitsuokella, Mobiluncus, Moellerella, Moraxella, Morganella, Mycobacterium, Mycoplasma, Myroides, Neisseria, Nocardia, Nocardiopsis, Ochrobactrum, Oeskovia, Oligella, Orientia, Paenibacillus, Pantoea, Parachlamydia, Pasteurella, Pediococcus, Peptococcus, Peptostreptococcus, Photobacterium, Photorhabdus, Plesiomonas, Porphyrimonas, Prevotella, Propionibacterium, Proteus, Providencia, Pseudomonas, Pseudonocardia, Pseudoramibacter, Psychrobacter, Rahnella, Ralstonia, Rhodococcus, Rickettsia Rochalimaea Roseomonas, Rothia, Ruminococcus, Salmonella, Selenomonas, Serpulina, Serratia, Shewenella, Shigella, Simkania, Slackia, Sphingobacterium, Sphingomonas, Spirillum, Staphylococcus, Stenotrophomonas, Stomatococcus, Streptobacillus, Streptococcus, Streptomyces, Succinivibrio, Sutterella, Suttonella, Tatumella, Tissierella, Trabulsiella, Treponema, Tropheryma, Tsakamurella, Turicella, Ureaplasma, Vagococcus, Veillonella, Vibrio, Weeksella, Wolinella, Xanthomonas, Xenorhabdus, Yersinia, and Yokenella. Other examples of bacterium include Mycobacterium tuberculosis, M. bovis, M. typhimurium, M. bovis strain BCG, BCG substrains, M. avium, M. intracellulare, M. africanum, M. kansasii, M. marinum, M. ulcerans, M. avium subspecies paratuberculosis, Staphylococcus aureus, Staphylococcus epidermidis, Staphylococcus equi, Streptococcus pyogenes, Streptococcus agalactiae, Listeria monocytogenes, Listeria ivanovii, Bacillus anthracis, B. subtilis, Nocardia asteroides, and other Nocardia species, Streptococcus viridans group, Peptococcus species, Peptostreptococcus species, Actinomyces israelii and other Actinomyces species, and Propionibacterium acnes, Clostridium tetani, Clostridium botulinum, other Clostridium species, Pseudomonas aeruginosa, other Pseudomonas species, Campylobacter species, Vibrio cholerae, Ehrlichia species, Actinobacillus pleuropneumoniae, Pasteurella haemolytica, Pasteurella multocida, other Pasteurella species, Legionella pneumophila, other Legionella species, Salmonella typhi, other Salmonella species, Shigella species Brucella abortus, other Brucella species, Chlamydi trachomatis, Chlamydia psittaci, Coxiella burnetti, Escherichia coli, Neiserria meningitidis, Neiserria gonorrhea, Haemophilus influenzae, Haemophilus ducreyi, other Hemophilus species, Yersinia pestis, Yersinia enterolitica, other Yersinia species, Escherichia coli, E. hirae and other Escherichia species, as well as other Enterobacteria, Brucella abortus and other Brucella species, Burkholderia cepacia, Burkholderia pseudomallei, Francisella tularensis, Bacteroides fragilis, Fudobascterium nucleatum, Provetella species, and Cowdria ruminantium, or any strain or variant thereof.

Examples of parasites include, but are not limited to, Toxoplasma gondii, Plasmodium falciparum, Plasmodium vivax, Plasmodium malariae, other Plasmodium species, Trypanosoma brucei, Trypanosoma cruzi, Leishmania major, other Leishmania species, Schistosoma mansoni, other Schistosoma species, and Entamoeba histolytica, or any strain or variant thereof.

Examples of viruses include, but are not limited to, Herpes simplex virus type-1, Herpes simplex virus type-2, Cytomegalovirus, Epstein-Barr virus, Varicella-zoster virus, Human herpesvirus 6, Human herpesvirus 7, Human herpesvirus 8, Variola virus, Vesicular stomatitis virus, Hepatitis A virus, Hepatitis B virus, Hepatitis C virus, Hepatitis D virus, Hepatitis E virus, Rhinovirus, Coronavirus, Influenza virus A, Influenza virus B, Measles virus, Polyomavirus, Human Papilomavirus, Respiratory syncytial virus, Adenovirus, Coxsackie virus, Dengue virus, Mumps virus, Poliovirus, Rabies virus, Rous sarcoma virus, Yellow fever virus, Ebola virus, Marburg virus, Lassa fever virus, Eastern Equine Encephalitis virus, Japanese Encephalitis virus, St. Louis Encephalitis virus, Murray Valley fever virus, West Nile virus, Rift Valley fever virus, Rotavirus A, Rotavirus B, Rotavirus C, Sindbis virus, Simian Immunodeficiency cirus, Human T-cell Leukemia virus type-1, Hantavirus, Rubella virus, Simian Immunodeficiency virus, Human Immunodeficiency virus type-1, Vaccinia virus, SARS virus, and Human Immunodeficiency virus type-2, or any strain or variant thereof.

Referring again to FIG. 1A, the filter 230 is effective for capturing cells, viruses, or biomolecules released from a cell or virus, as a fluid sample flows through the filter. The average pore size of the filter 230 is selected to be small enough to trap the desired analyte (e.g., cells, viruses, nucleic acids or proteins). In general, the pore size is within the range of from about 0.01 micron to about 10 micron. Larger pore sizes are less prone to plugging with impurities generally found in some samples. In one embodiment, the filter 230 has an average pore size of about 0.45 micron. In another embodiment, the filter 170 has an average pore size of about 0.2 micron. Smaller pore sizes may be needed to trap DNA or RNA fragments. For example, genomic DNA in its “naked” form has a radius of gyration of 270 nm for a 6600 bp sequence.

The filter 230 can be composed of any microporous material that has a high concentration of small, uniform holes or pores or that can be converted to such a material. Examples of such materials include, but are not limited to, inorganic materials, polymers, and the like. In one embodiment, the microporous material is a ceramic, a metal, carbon, glass, a metal oxide, or a combination thereof. In another embodiment, the microporous material includes a track etch material, an inorganic electrochemically formed material, and the like. The phrase “inorganic electrochemically formed material” is defined herein as a material that is formed by the electroconversion of a metal to a metal oxide. The phrase “track etch material” is defined herein as a material that is formed with the use of ionizing radiation on a polymer membrane to produce holes in the material. Such materials are commercially available. When the microporous material is a metal oxide, the metal oxide includes aluminum oxide, zirconium oxide, titanium oxide, a zeolite, or a combination thereof. The metal oxide can also contain one or more metal salts in varying amounts. For example, aluminum salts such as aluminum phosphate, aluminum chloride, or aluminum sulfate can be part of the microporous material.

In another embodiment, the microporous material is an inorganic electroformed metal oxide. Such ceramic membranes are available from Whatman, Inc. and distributed under the trade names Anopore™ and Anodisc™. Anopore membranes have a honeycomb type structure with each pore approximately 0.2 micron in diameter by 50 microns long. The Anopore membranes are composed of predominantly aluminum oxide with a small amount (5-10%) of aluminum phosphate. In another embodiment, the microporous material can be aluminum or titanium that has been anodized. Anodization is a technique known in the art that is used to produce an oxide layer on the surface of the aluminum or titanium.

The microporous material can also be chemically modified to enhance surface localization of cell lysate. For example, since nucleic acids are negatively charged molecules, the microporous material can be treated to have a positive charge with various chemicals so that the nucleic acids stick near the surface of the microporous material through ionic attractive forces. Such weak attractive forces aid in keeping the nucleic acids from passing through the microporous material. In one embodiment, the microporous material can be pretreated with silanization reagents including, but not limited to, aminopropyltrimethoxysilane (APS), ethylenediaminopropyltrimethoxysilane (EDAPS), or other amino silane reagents to impart a slight positive surface charge. In another embodiment, the microporous material can be pretreated with polymer materials, including but not limited to polylysine, to impart a slight surface charge to enhance lysate localization. Additionally, the microporous material can be modified with neutral reagents such as a diol, an example of which is acid hydrolyzed glycidoxypropyltrimethoxysilane (GOPS), to vary lysate retention.

Referring again to FIG. 1, he reagents may be placed in the cartridge during manufacture, e.g., as dried reagents or aqueous solutions. The particular format is selected based on a variety of parameters, including whether the interaction is solution-phase or solid-phase, the inherent thermal stability of the reagent, speed of reconstitution, and reaction kinetics. Reagents containing compounds that are thermally unstable when in solution can be stabilized by drying using techniques such as lyophilization. Additives, such as simple alcohol sugars, methylcelluloses, and bulking proteins may be added to the reagent before drying to increase stability or reconstitutability. Alternatively, reagents may be exogenously introduced into the cartridge 200 before use, e.g., through sealable openings in the reagent chamber 250.

Another aspect of the present invention relates to a method for detecting an analyte in a liquid sample. The method comprises the steps of loading the liquid sample into a cartridge containing a filter having a pore size sufficient to captured the analyte when the liquid sample flows through the filter, the filter is located in a reaction chamber in said cartridge; introducing into the reaction chamber reagents from a reagent chamber in the cartridge to initiate an amplification reaction; and detecting a product of the amplification reaction. In one embodiment, the sample is loaded into the cartridge from a sample loader through a sample port of the cartridge. In another embodiment, the reagents in the reagent chamber is prepared by applying a pressure at a pressure port of the cartridge to break a septum between a buffer reservoir and the reagent chamber, the buffer enters the reagent chamber and reconstitute reagents from a lyophilized reagent pellet. In another embodiment, the product of the amplification reaction is detected by fluorescence. In yet another embodiment, the amplification reaction is an EXPAR reaction, an SDA reaction, or a PCR reaction.

The embodiments illustrated and discussed in this specification are intended only to teach those skilled in the art the best way known to the inventors to make and use the invention. Nothing in this specification should be considered as limiting the scope of the present invention. The above-described embodiments of the invention may be modified or varied, and elements added or omitted, without departing from the invention, as appreciated by those skilled in the art in light of the above teachings. It is therefore to be understood that, within the scope of the claims and their equivalents, the invention may be practiced otherwise than as specifically described.

What is claimed is:

1. A filter-based device for detecting an analyte is a liquid sample, comprising:
a cartridge comprising:
a reaction chamber having a filter in a sample flow path for capturing the analyte in the sample;
a waste reservoir connected to the reaction chamber via the filter, said waste reservoir collects the flow-through sample from the filter; and
a reagent chamber containing reagents for an amplification reaction in the reaction chamber, said reagent chamber is in fluid communication with the reaction chamber after all the sample enters the waste reservoir.

2. The filter-based device of claim 1, wherein said waste reservoir is connected to said filter through a check valve that prevents flow-through sample from entering the reaction chamber.

3. The filter-based device of claim 1, wherein said cartridge further comprises a buffer reservoir containing a buffer that is used to reconstitute the reagents from a lyophilized reagent pellet in the reagent chamber.

4. The filter-based device of claim 3, wherein said buffer reservoir is separated from the reagent chamber by a septum.

5. The filter-based device of claim 1, wherein said reagent chamber is connected to said reaction chamber via a check valve that prevents the liquid sample from entering the reagent chamber.

6. The filter-based device of claim 1, wherein said cartridge further comprises a sample port.

7. The filter-based device of claim 6, further comprising a sample loader for loading the liquid sample into the cartridge through the sample port.

8. The filter-based device of claim 1, further comprising a base unit comprising an optical device for detecting a signal from said reaction chamber.

9. The filter-based device of claim 8, wherein said optical device is a fluorescence detector comprising light-emitting diode (LED) illuminators and a diode array.

10. The filter-based device of claim 8, wherein said base unit further comprising a heating/cooling device.

11. The filter-based device of claim 8, wherein said base unit further comprising a device capable of applying a pressure to a pressure port of said cartridge.

12. The filter-based device of claim 11, wherein said device capable of applying a pressure to a pressure port of said cartridge is a syringe pump.

13. The filter-based device of claim 8, wherein said base unit further comprising a cartridge nest into which the cartridge is placed for processing.

14. The filter-based device of claim 1, wherein said reaction chamber further comprises a spot array having spots that fluoresce after the amplification reaction.

15. The filter-based device of claim 14, wherein said reaction chamber is heated during the amplification reaction.

16. The filter-based device of claim 14, wherein said spot array is in close proximity to said filter to enable short diffusional path length of targets to said spot array for in situ amplification.

17. A method for detecting an analyte in a liquid sample, said method comprising:
loading a liquid sample into a cartridge containing a filter having a pore size sufficient to captured said analyte when said sample flows through said filter, said filter is located in a reaction chamber in said cartridge;
introducing into said reaction chamber reagents from a reagent chamber in said cartridge to initiate an amplification reaction; and
detecting a product of the amplification reaction.

18. The method of claim 17, further comprising:
applying a pressure at a pressure port of said cartridge to break a septum between a buffer reservoir and said reagent chamber to reconstitute reagents from a lyophilized reagent pellet.

19. The method of claim 17, wherein said product of the amplification reaction is detected by fluorescence.

20. The method of claim 17, wherein said amplification reaction is an exponential amplification reaction (EXPAR), or a strand displacement amplification (SDA), or a polymerase chain reaction (PCR).
